(19) United States
(12) Patent Application Publication
(10) Pub. No.: US 2017/0270961 A1
(43) Pub. Date: Sep. 21, 2017

(54) OPTICAL INFORMATION REPRODUCING DEVICE AND OPTICAL INFORMATION REPRODUCING METHOD

(71) Applicant: Hitachi-LG Data Storage, Inc., Tokyo (JP)

(72) Inventors: Kazuyuki TAJIMA, Tokyo (JP); Yusuke NAKAMURA, Tokyo (JP)

(21) Appl. No.: 15/456,899

(22) Filed: Mar. 13, 2017

(30) Foreign Application Priority Data
Mar. 16, 2016 (JP) 2016-051856

(51) Int. Cl. G11B 20/10; G06N 99/00; G11B 20/18; G03H 1/26; G11B 7/0065

(52) U.S. Cl. CPC G11B 20/10481; G03H 1/265; G11B 7/0065; G11B 20/18; G06N 99/005

(57) ABSTRACT

An optical information reproducing device which reproduces information from an optical information storage medium recording, as the information, a hologram which is an interference pattern between a signal beam and a reference beam, the hologram corresponding to an angle of the reference beam being a page, the device includes an image distortion learning unit which detects, based on a two-dimensional reproduction signal generated by reproducing the page, a marker which is a known pattern for detecting a position of two-dimensional data relating to the page, and learns a distortion amount which is the difference between a position of the detected marker and an ideal position, a detection unit which detects, based on the distortion amount, position information on the marker from the page, and an image distortion correction unit which corrects, based on the position information on the marker detected by the detection unit, an image distortion in the page.

### BACKGROUND

Technical Field

The present invention relates to a device and method for reproducing information from an optical information storage medium using holography.

Related Art

As a method for improving quality of a reproduction signal from a holographic memory, Abstract of JP 2008-536158 A discloses a method for processing data pixels in a holographic data storage system. Abstract of JP 2008-536158 A further discloses that the method includes assigning predetermined reserved blocks throughout each data page, where each reserved block comprises known pixel patterns, determining position errors of the data page by computing the best match between regions of the data page and the predetermined reserved blocks, and compensating the data pixels at the detector in accordance with the corresponding position errors of the data page.

As a technique for correcting an erroneously detected marker in reproduction of a hologram, for example, Abstract of WO 2013/150565 A discloses that an optical information reproducing device includes a detection unit that detects the position information of a marker as a well-known pattern, a detection error position estimating unit that estimates presence/absence of detection error in the position information of the marker and estimates the position where the detection error occurs if there is detection error, a position correcting unit that corrects the marker position information of the detection error position specified by the detection error position estimating unit, and a signal detection unit that detects each signal from within the page based on the corrected marker position information.

### SUMMARY

As a technique for improving quality of a reproduction image, JP 2008-536158 A discloses a technique for compensating a distortion or a position shift of the reproduction image using a known pixel pattern included in page data.

Furthermore, WO 2013/150565 A discloses a technique for determining, when quality of a reproduction image is poor and a known pattern is erroneously detected, the erroneous detection and for correcting marker information on the erroneously detected part based on peripheral known pattern information.

At this time, when a nonlinear distortion occurs in a reproduction image, a known pattern disposed in page data cannot be detected. JP 2008-536158 A and WO 2013/150565 A do not mention the case in which a distortion, such as a nonlinear distortion, occurs and a known pattern cannot be detected.

Thus, a purpose of the present invention is to detect a known pattern according to a nonlinear distortion occurring in a reproduction image and to improve quality of a reproduction signal.

The above problem is to be solved by, for example, the invention disclosed in claims.

According to embodiments of the present invention, it is possible to detect a marker by marker position estimation in which a distortion amount is estimated even in an image having a distortion which interferes with marker detection, and to improve quality of a reproduction signal.

### BRIEF DESCRIPTION OF DRAWINGS

FIG. 1 is a diagram illustrating an example of a distortion amount learning method in the present embodiment;

FIG. 2 is a diagram illustrating a configuration example of an optical information recording/reproducing device in the present embodiment;

FIG. 3 is a diagram illustrating a configuration example of an optical pickup in the present embodiment;

FIG. 4 is a diagram illustrating a configuration example of the optical pickup in the present embodiment;

FIG. 5A is a flowchart of an operation procedure of the optical information recording/reproducing device in the present embodiment;

FIG. 5B is a flowchart of an operation procedure of the optical information recording/reproducing device in the present embodiment;

FIG. 5C is a flowchart of an operation procedure of the optical information recording/reproducing device in the present embodiment;

FIG. 6 is a diagram illustrating a configuration example of a signal generation circuit in the present embodiment;

FIG. 7 is a diagram illustrating a configuration example of a signal processing circuit in the present embodiment;

FIG. 8 is a flowchart of an operation procedure of the signal generation circuit in the present embodiment;

FIG. 9 is a flowchart of an operation procedure of the signal processing circuit in the present embodiment;

FIG. 10 is a diagram illustrating an example of usage of a learned distortion amount for a marker search range in the present embodiment;

FIG. 11 is a diagram illustrating a configuration example of a signal processing circuit which learns an image distortion in a learning page in the present embodiment;

FIG. 12 is a flowchart of an operation procedure of the signal processing circuit which learns an image distortion in a learning page in the present embodiment;

FIG. 13 is a diagram illustrating an example of a distortion amount learning method using a learning page in the present embodiment;

FIG. 14 is a diagram illustrating a configuration example of a signal processing circuit which learns an image distortion according to deterioration of reproduction quality in the present embodiment;

FIG. 15 is a flowchart of an operation procedure of the signal processing circuit which learns an image distortion according to deterioration of reproduction quality in the present embodiment;

FIG. 16 is a diagram illustrating an example of a distortion amount learning method using a normal page in the present embodiment;

FIG. 17 is a diagram illustrating an example of a distortion amount learning method using an inter-page marker in the present embodiment; and

FIG. 18 is a diagram illustrating an example of usage of a learned distortion amount for a marker search range in the present embodiment.

### DETAILED DESCRIPTION

Hereinafter, embodiments of the present invention are described with reference to the drawings.

### First Embodiment

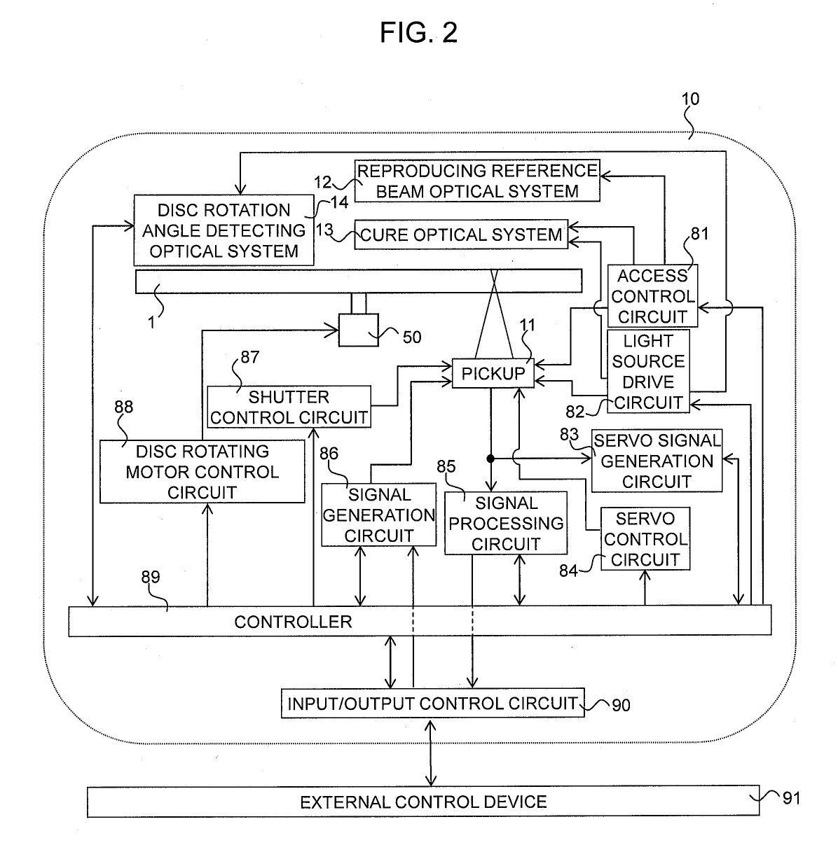

FIG. 2 is a block diagram illustrating a recording/reproducing device, which records or reproduces digital information using holography, for an optical information storage medium.

An optical information recording/reproducing device 10 is connected with an external control device 91 through an input/output control circuit 90. When recording information, the optical information recording/reproducing device 10 receives an information signal to be recorded from the external control device 91 with the input/output control circuit 90. When reproducing information, the optical information recording/reproducing device 10 transmits a reproduced information signal to the external control device 91 with the input/output control circuit 90.

The optical information recording/reproducing device 10 includes a pickup 11, a reproducing reference beam optical system 12, a cure optical system 13, a disc rotation angle detecting optical system 14, and a rotating motor 50, and an optical information storage medium 1 is configured so as to be rotated by the rotating motor 50.

The pickup 11 exposes the optical information storage medium 1 to a reference beam and a signal beam, and records digital information in the optical information storage medium 1 using holography. At this time, an information signal to be recorded is transmitted to a spatial light modulator in the pickup 11 through a signal generation circuit 86 by a controller 89, and the signal beam is modulated by the spatial light modulator.

When information recorded in the optical information storage medium 1 is reproduced, the reproducing reference beam optical system 12 generates a light wave which causes a reference beam emitted from the pickup 11 to enter the optical information storage medium 1 in the opposite direction from the direction at the time of recording. A light detector, which is described later, in the pickup 11 detects a recovered beam to be reproduced with a reproducing reference beam, and a signal processing circuit 85 reproduces a signal.

The exposure time of the optical information storage medium 1 exposed to the reference beam and the signal beam can be adjusted by controlling an opening/closing time of a shutter in the pickup 11 by the controller 89 through a shutter control circuit 87.

The cure optical system 13 generates a light beam used for pre-curing and post-curing the optical information storage medium 1. The pre-curing is pre-processing in which a desired position in the optical information storage medium. 1 is exposed to a predetermined light beam before the desired position is exposed to the reference beam and the signal beam when information is recorded in the desired position. The post-curing is post-processing in which the desired position in the optical information storage medium 1 is exposed to a predetermined light beam so that further information is not added in the desired position after the information is recorded in the desired position.

The disc rotation angle detecting optical system 14 detects a rotation angle of the optical information storage medium 1. When the optical information storage medium 1 is adjusted to a predetermined rotation angle, the disc rotation angle detecting optical system 14 detects a signal according to a rotation angle, and the controller 89 controls the rotation angle of the optical information storage medium 1 through a disc rotating motor control circuit 88 using the detected signal.

A light source drive circuit 82 supplies a predetermined light source drive current to the light sources in the pickup 11, the cure optical system 13, and the disc rotation angle detecting optical system 14, and each light source emits alight beam at a predetermined amount of light.

Furthermore, the pickup 11 and the cure optical system 13 each have a mechanism with which the position can be slid in a radial direction of the optical information storage medium 1, and the position control is performed through an access control circuit 81.

Incidentally, a recording technique using a principle of angle multiplexing of holography tends to have an extremely small permissible error to a shift of a reference beam angle.

Thus, a servo mechanism needs to be provided in the optical information recording/reproducing device 10 to correct, through a servo control circuit 84, a shift amount of the reference beam angle, which is detected by a mechanism provided in the pickup 11, using a servo controlling signal generated by a servo signal generation circuit 83.

Note that, in the pickup 11, the cure optical system 13, and the disc rotation angle detecting optical system 14, some or all of optical system configurations may be simplified by being integrated into one.

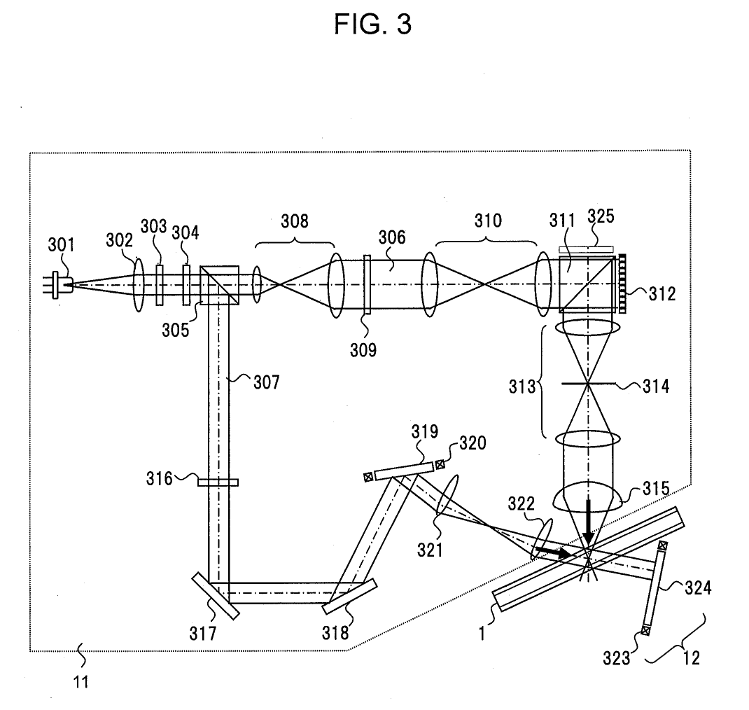

FIG. 3 illustrates a recording principle in a configuration example of a basic optical system of the pickup 11 in the optical information recording/reproducing device 10. A light beam emitted from a light source 301 passes through a collimator lens 302 and enters a shutter 303. When the shutter 303 is opened, the light beam passes through the shutter 303, then, passes through an optical element 304 constituted by, for example, a half wave plate or the like to control the polarization direction so that a light amount ratio between a p-polarization and an s-polarization is to be a desired ratio, and enters a polarization beam splitter (PBS) prism 305.

The light beam passing through the PBS prism 305 serves as a signal beam 306, passes through a beam expander 308 to expand the light beam diameter, then, passes through a phase mask 309, a relay lens 310, and a PBS prism 311, and enters the spatial light modulator 312.

The signal beam to which information is added by the spatial light modulator 312 is reflected by the PBS prism 311, and passes through a relay lens 313 and an aperture 314. Thereafter, the signal beam is condensed on the optical information storage medium 1 by an objective lens 315.

On the other hand, the light beam reflected by the PBS prism 305 serves as a reference beam 307, passes through a polarization direction conversion element 316 to set the direction in a predetermined polarization direction according to the time of recording or reproducing, and enters a galvano mirror 319 through a mirror 317 and a mirror 318. Since the angle of the galvano mirror 319 can be adjusted by an actuator 320, the angle of incidence of the reference beam entering the optical information storage medium 1 after passing through a lens 321 and a lens 322 can be set to a desired angle. Note that, to set the angle of incidence of the reference beam, an element which converts a wavefront of the reference beam may be used instead of the galvano mirror.

By causing the signal beam and the reference beam to enter the optical information storage medium 1 so as to be superimposed on each other in this manner, an interference pattern is formed in the optical information storage medium 1, and the pattern is written in the optical information storage medium 1 to record the information. Furthermore, since the angle of incidence of the reference beam entering the optical information storage medium 1 can be changed by the galvano mirror 319, it is possible to perform angular multiplexing recording.

Hereinafter, in a hologram recorded in the same area by changing reference beam angles, a hologram corresponding to each reference beam angle is referred to as a page, and a set of pages angular-multiplexed in the same area is referred to as a book.

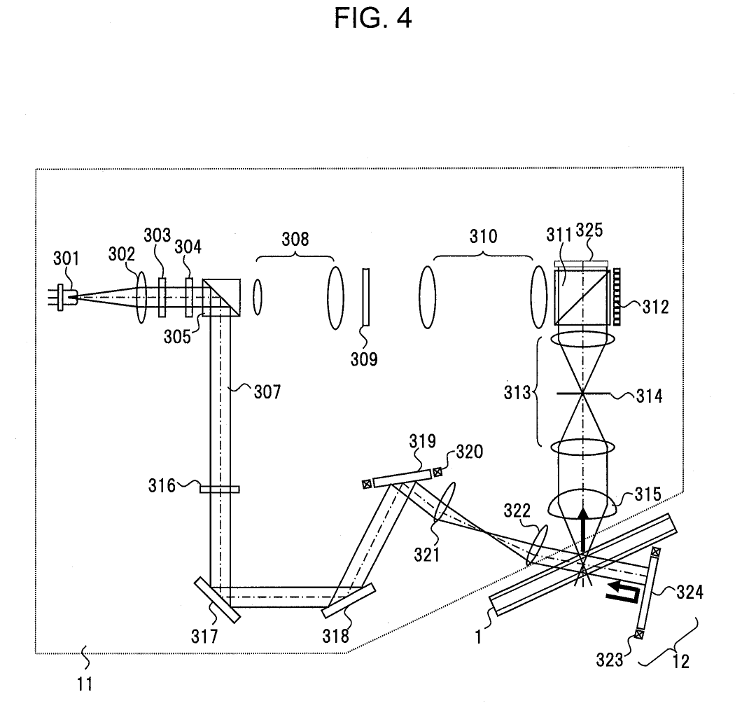

FIG. 4 illustrates a reproducing principle in a configuration example of a basic optical system of the pickup 11 in the optical information recording/reproducing device 10. When the recorded information is reproduced, as described above, by causing the reference beam to enter the optical information storage medium 1, and causing the light beam passing through the optical information storage medium 1 to be reflected by a galvano mirror 324 the angle of which can be adjusted by an actuator 323, a reproducing reference beam is generated.

The recovered beam reproduced with the reproducing reference beam passes through the objective lens 315, the relay lens 313, and the aperture 314. Thereafter, the recovered beam passes through the PBS prism. 311, and enters the light detector 325, and the recorded signal can be reproduced. As the light detector 325, an imaging element, such as a CMOS image sensor or a CCD image sensor, can be used, and any element may be used as long as page data can be reproduced.

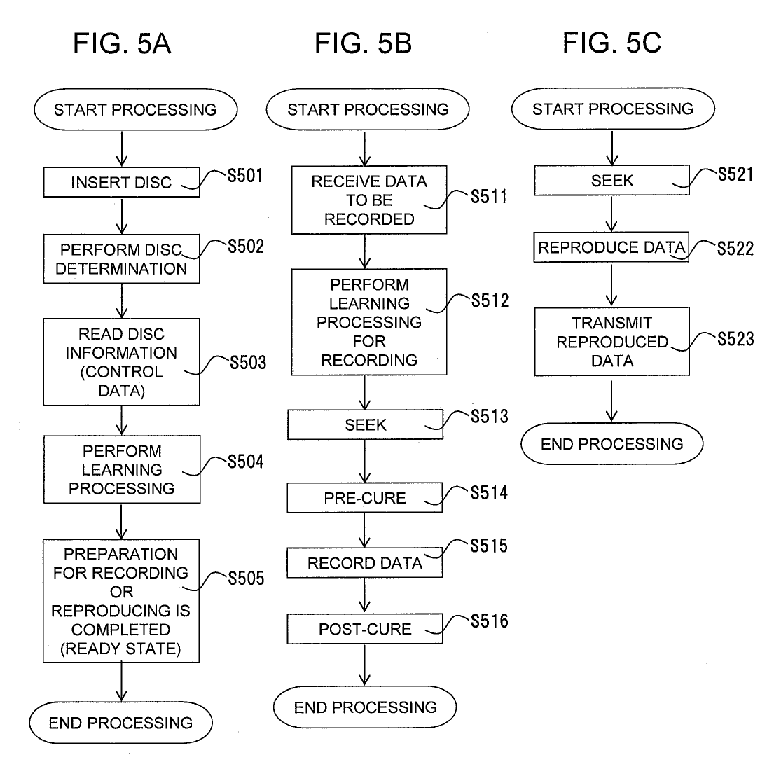

FIGS. 5A to 5C are flowcharts of recording/reproducing operation procedures of the optical information recording/reproducing device 10. Here, procedures related to recording and reproducing using holography are described.

FIG. 5A is the flowchart of an operation procedure until preparation for recording or reproducing is completed after the optical information storage medium. 1 is inserted to the optical information recording/reproducing device 10 (ready state). FIG. 5B is the flowchart of an operation procedure from the ready state until information is recorded in the optical information storage medium 1. FIG. 5C is the flowchart of an operation procedure from the ready state until the information recorded in the optical information storage medium 1 is reproduced.

As shown in FIG. 5A, when the optical information storage medium 1 is inserted (S501), the optical information recording/reproducing device 10 performs disc determination as to whether, for example, the inserted optical information storage medium 1 contains digital information which is recorded or reproduced using holography (S502).

As a result of the disc determination, when it is determined that the optical information storage medium 1 contains the digital information which is recorded or reproduced using holography, the optical information recording/reproducing device 10 reads control data in the optical information storage medium 1 (S503), and acquires, for example, information on the optical information storage medium 1 or information on various setting conditions at the time of recording or reproducing.

By performing various adjustments according to the control data and learning processing related to the pickup 11 (S504), the optical information recording/reproducing device 10 is ready for recording or reproducing (S505).

As shown in FIG. 5B, in the operation procedure from the ready state until the information is recorded, first, data to be recorded is received (S511), and the information corresponding to the data is transmitted to the spatial light modulator in the pickup 11.

Thereafter, to record high-quality information in the optical information storage medium 1, various types of learning processing for recording, such as the power optimization of the light source 301 or the optimization of the exposure time by the shutter 303, is appropriately performed in advance (S512).

Thereafter, in a seek operation (S513), the light beams emitted from the pickup 11 and the cure optical system 13 are positioned to a predetermined position on the optical information storage medium 1 by controlling the access control circuit 81. When the optical information storage medium 1 has address information, it is confirmed that they are positioned at the desired position by reproducing the address information. If they are not positioned at the desired position, the shift amount from the predetermined position is calculated and the positioning is repeated.

Thereafter, the predetermined area is pre-cured using the light beam emitted from the cure optical system 13 (S514), and the data is recorded using the reference beam and the signal beam which are emitted from the pickup 11 (S515).

After the data is recoded, the post-curing is performed using the light beam emitted from the cure optical system 13 (S516). The data may be verified as needed.

As shown in FIG. 5C, in the operation procedure from the ready state until the recoded information is reproduced, first, the light beams emitted from the pickup 11 and the reproducing reference beam optical system 12 are positioned at a predetermined position on the optical information storage medium 1 by controlling the access control circuit 81 in the seek operation (S521). When the optical information storage medium 1 has address information, it is confirmed that they are positioned at the desired position by reproducing the address information. If they are not positioned at the desired position, the shift amount from the predetermined position is calculated and the positioning is repeated.

Thereafter, the reference beam is emitted from the pickup 11, the information recorded in the optical information storage medium 1 is read (S522), and the reproduced data is transmitted (S523).

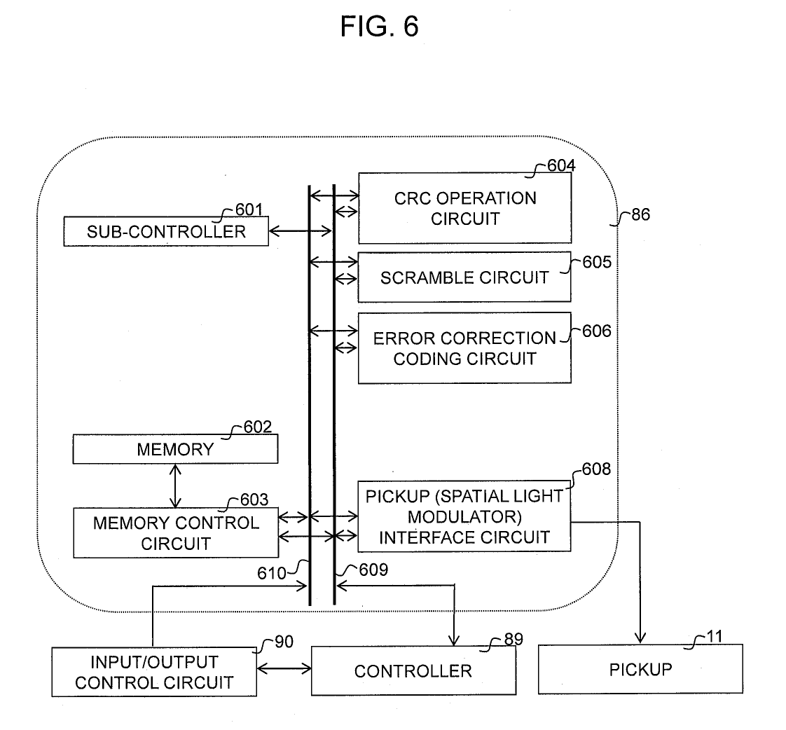

Next, with reference to FIGS. 6 to 8, signal generation and processing at the time of recording/reproducing are described.

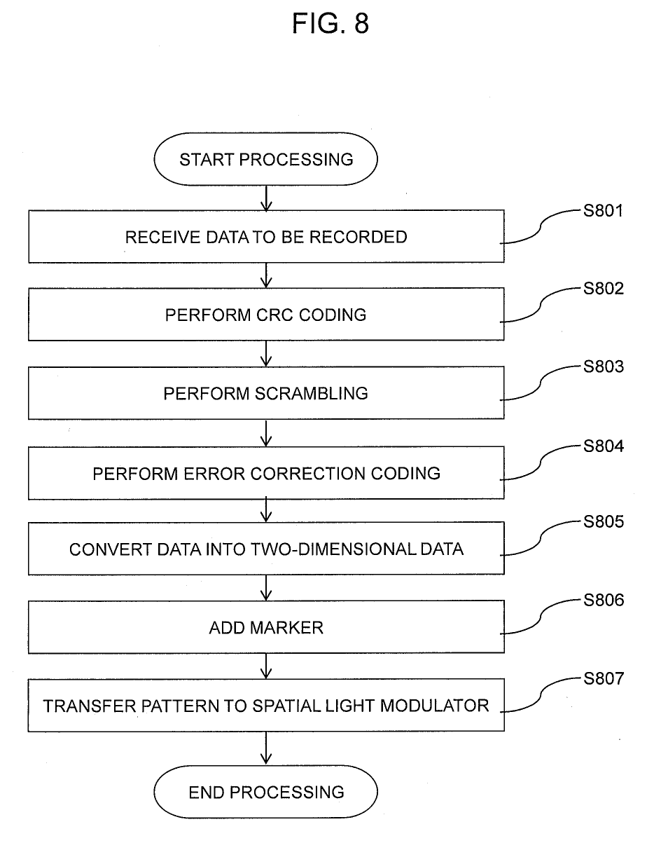

First, with reference to FIGS. 6 and 8, a configuration of the signal generation circuit 86 of the optical information recording/reproducing device 10, and recorded data processing when data is recorded are described.

FIG. 6 is a block diagram illustrating the signal generation circuit 86 of the optical information recording/reproducing device 10. FIG. 8 is a flowchart of a data processing procedure of the signal generation circuit 86 at the time of recording, and especially a procedure for generating two-dimensional data to be recorded in a medium from user data.

When the input of the user data to the input/output control circuit 90 is started, the input/output control circuit 90 notifies the controller 89 that the input of the user data is started. The controller 89 instructs, in response to the notification, the signal generation circuit 86 to record one page of data input from the input/output control circuit 90.

When the signal generation circuit 86 receives the user data (S801), the processing instruction from the controller 89 is notified to a sub-controller 601 in the signal generation circuit 86 through a control line 609.

The sub-controller 601 controls, in response to the notification, all signal processing circuits through the control line 609 so that the signal processing circuits operate in parallel.

A memory control circuit 603 controls a memory 602 so as to store, through a data line 610, the user data input from the input/output control circuit 90.

When the user data stored in the memory 602 reaches a certain amount, a CRC operation circuit 604 divides the user data into a plurality of data sequences and performs CRC coding to each data sequence to perform error detection at the time of reproducing (S802).

A scramble circuit 605 performs scrambling in which a pseudo-random number data sequence is added to the data sequence, to which the CRC cording is performed, in order to prevent the repetition of the same pattern by equalizing the number of on-pixels with the number of off-pixels (S803).

An error correction coding circuit 606 performs error correction coding in which a parity data sequence such as Reed-Solomon coding is added in order to perform error correction at the time of reproducing (S804).

A pickup interface circuit 608 converts the data sequence into M×N two-dimensional data, and generates one page of two-dimensional data by repeating the conversion for one page of data (S805), adds, to the generated two-dimensional data, a marker which serves as a criterion for image position detection or for image distortion correction at the time of reproducing (S806), and transfers the data to the spatial light modulator 312 (S807).

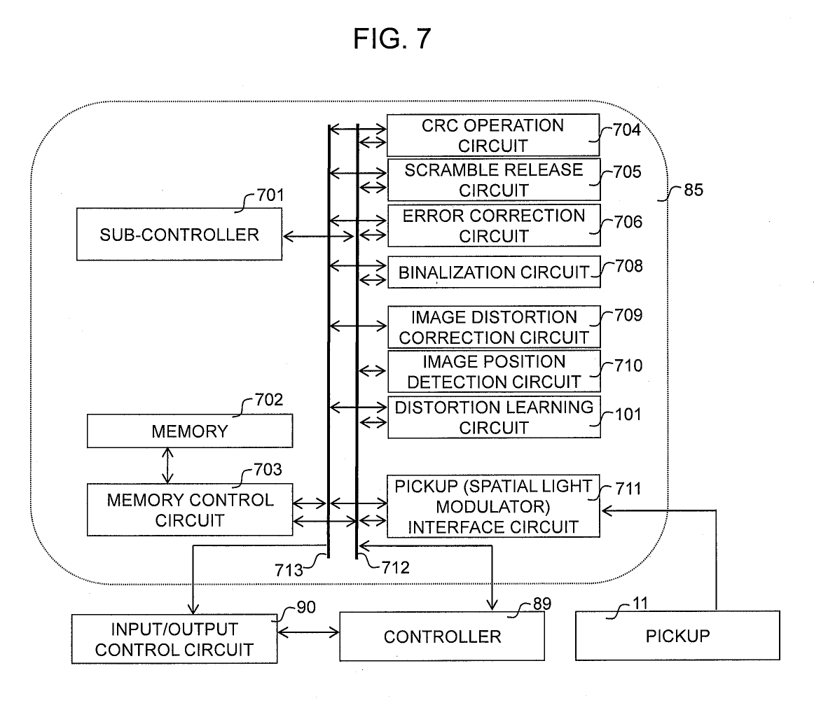

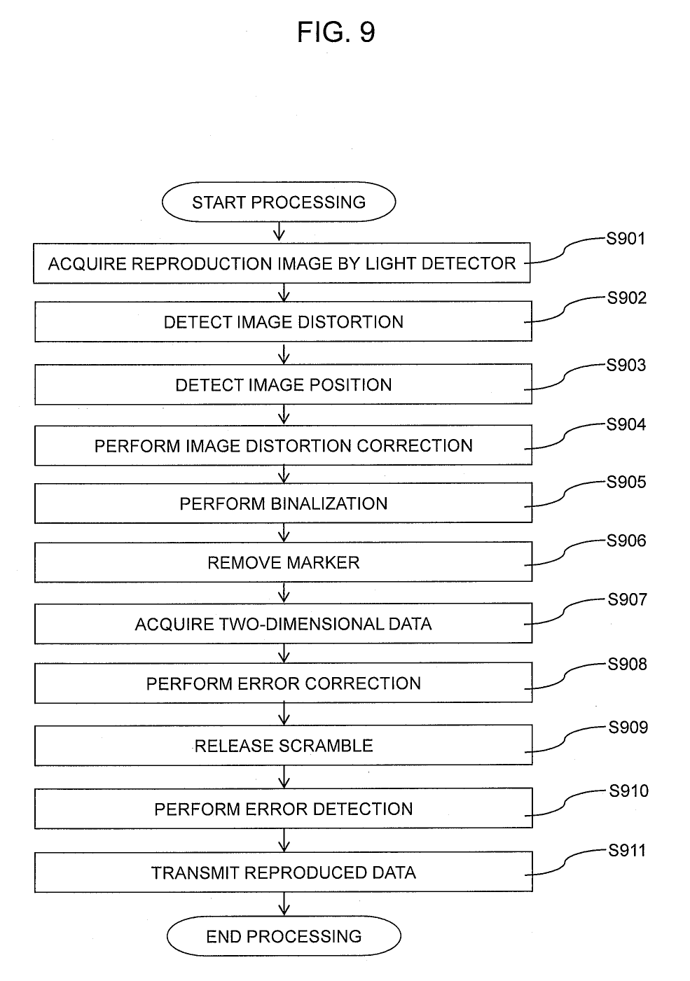

Next, with reference to FIGS. 7 and 9, a configuration of the signal processing circuit 85 of the optical information recording/reproducing device 10 and reproduced data processing when data is reproduced are described.

FIG. 7 is a block diagram illustrating the signal processing circuit 85 of the optical information recording/reproducing device 10. FIG. 9 is a flowchart of a data processing procedure of the signal processing circuit 85 at the time of reproducing.

When the light detector 325 in the pickup 11 detects image data (S901), the controller 89 instructs the signal processing circuit 85 to reproduce one page of data input from the pickup 11.

The processing instruction from the controller 89 is notified to a sub-controller 701 in the signal processing circuit 85 through a control line 712. The sub-controller 701 controls, in response to the notification, all signal processing circuits through a control line 712 so that the signal processing circuits operate in parallel.

A memory control circuit 703 controls a memory 702 so as to store, through a data line 713, image data input from the pickup 11 through a pickup interface circuit 711.

A distortion learning circuit 101 learns a distortion amount of a reproduction image based on the data stored in the memory 702 (S902).

When the data stored in the memory 702 reaches a certain amount, an image position detection circuit 710 detects, based on the distortion amount calculated by the distortion learning circuit 101, the marker from the image data stored in the memory 702, and detects the image position based on the marker position (S903).

An image distortion correction circuit 709 performs distortion correction to the inclination, magnification, or distortion of the image using the detected marker (S904), and converts the image data into an assumed two-dimensional data size.

A binalization circuit 708 binalizes the two-dimensional data to determine each bit data of the bits constituting the two-dimensional data as “0” or “1” (S905), and stores the data in the memory 702 in the order of the output reproduced data. Thereafter, by removing the marker from the binalized data (S906), one page of two-dimensional data is acquired (S907).

An error correction circuit 706 converts the two-dimensional data acquired in this manner into a plurality of data sequences, performs error correction processing to each data sequence (S908), and removes a parity data sequence.

A scramble release circuit 705 releases the scramble for adding the pseudo-random number data sequence (S909).

A CRC operation circuit 704 performs error detection processing by CRC (S910) to delete a CRC parity, confirms that the user data in the memory 702 includes no error, and transfers the user data from the memory 702 to the input/output control circuit 90 (S911).

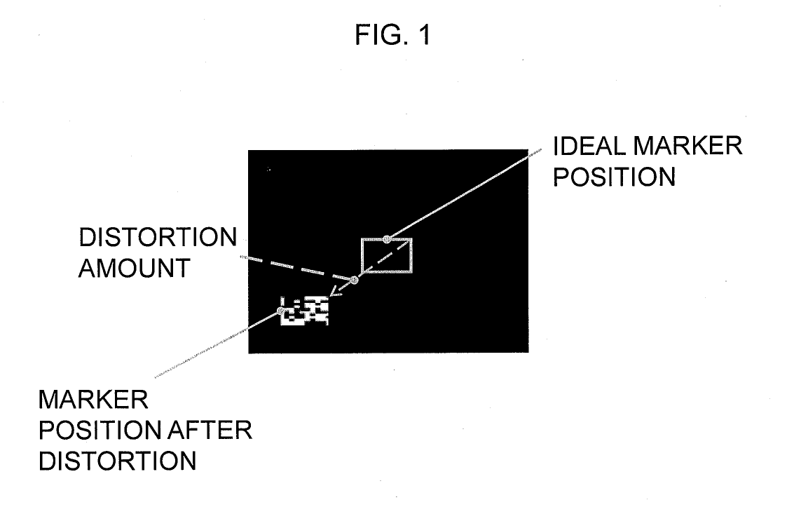

Here, in the above described optical information recording/reproducing device 10 in the present embodiment, distortion correction according to a nonlinear image distortion which is a feature of the present embodiment is detailedly described with reference to FIGS. 1 and 9 to 12.

In the present embodiment, a distortion amount is to be calculated by accurately detecting a known pattern although a nonlinear distortion occurs in a reproduction image, and reproduction quality when a normal page is reproduced is to be improved based on the calculated distortion amount.

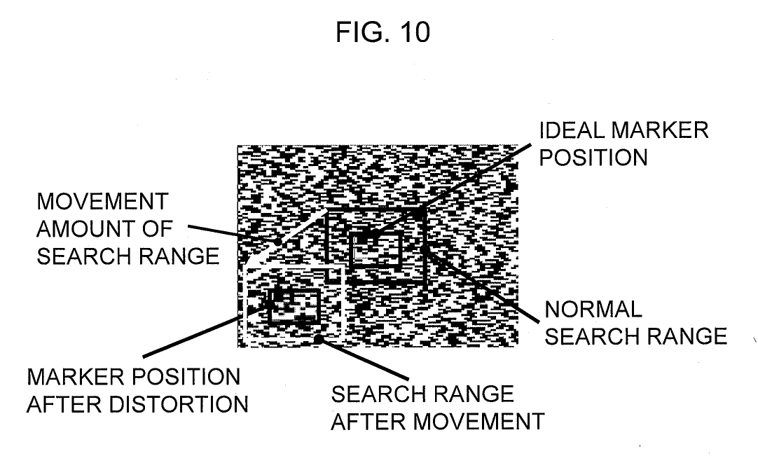

First, with reference to FIG. 1, the distortion learning circuit 101 in the first embodiment is described. FIG. 1 illustrates a distortion amount learned by the distortion learning circuit 101 in the first embodiment. A plurality of markers for correcting distortion is embedded in a page reproduction image. When it is assumed that the position of a marker in reproduction image data having no distortion is an ideal position, the difference between the ideal position of the marker held by the image position detection circuit 710 and the position of the marker after distortion detected by the distortion learning circuit 101 can be used as a distortion amount. When learning a distortion amount, the distortion amount can be detected by, for example, expanding a search range for a marker and detecting the marker. When it is assumed that the marker size is n×m, the lateral direction ratio of the marker size to the search range is h, and the longitudinal direction ratio is v, the lateral direction of the marker search range is represented by n×h, and the longitudinal direction is represented by m×v. By increasing the values of h and v, the marker search range can be expanded within the range in which other markers cannot be detected. Thereafter, the calculated distortion amount is recorded (S902), and the distortion amount is used in the operation of the image position detection circuit 710 when a normal page is reproduced. The operation of the image position detection circuit 710 using the distortion amount is described with reference to FIG. 10. FIG. 10 is a diagram illustrating a marker detection operation when a normal page is reproduced. FIG. 10 exemplifies the case in which a distortion equivalent to that in FIG. 1 occurs, and the case in which a marker position is out of a normal search range is described. The marker cannot be detected by searching the normal search range. However, by moving the search range based on the distortion amount calculated by the distortion learning circuit 101, the marker can be detected while the marker remains within the search range (S903). By performing such distortion amount calculation to all markers and by moving the search range corresponding to each marker according to the distortion amount, it is possible to accurately detect a marker and correct distortion although any kind of distortion occurs in a reproduction image.

Modifications to be described below are not limited to the present embodiment.

The description has been made based on the hologram recording technique by the angle multiplexing recording method in the present embodiment, but the present invention is not limited to the angle multiplexing recording method, and may be applied to other hologram recording techniques such as a shift multiplexing recording method, or signal processing in optical information storage mediums for data other than a hologram.

Furthermore, it has been described that a marker search range is expanded at the time of distortion learning in the present embodiment, but the marker search range may be expanded when a distortion amount is calculated and the distortion amount exceeds a predetermined threshold. In this case, the normal search range is searched for the marker when the distortion amount is small, and it is possible to reduce the processing time.

It has been described that a distortion amount is learned in a page to be reproduced and is directly used in the page in the present embodiment, but the page in which the distortion amount is learned may be different from the page in which the learned distortion amount is used. For example, by using, in the next page to be reproduced, the distortion amount learned after reproduction signal processing is completed, it is possible to more accurately perform distortion learning.

### Second Embodiment

The difference between the present embodiment and the first embodiment is that a learning page is used at the time of distortion learning instead of a normal page, and that a marker is detected by expanding a search range for the marker at the time of distortion learning. As described above, a distortion amount of an image can be estimated using a movement amount of a marker, but it is difficult to correctly detect the marker when a distortion occurs, and the marker can be out of the range if the search range is set in the vicinity of an ideal position when the marker after the distortion largely deviates from the ideal position.

In view of this situation, by learning a distortion amount in a learning page in which a marker alone is recorded, and expanding a search range for the marker at the time of distortion amount learning, the marker at a position largely shifted from an ideal position is to be detected in the present embodiment.

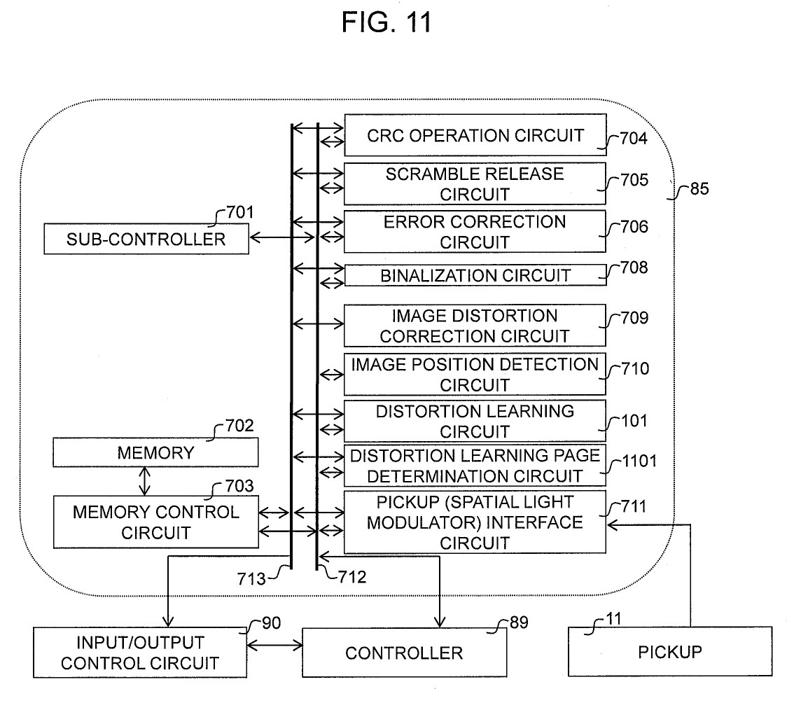

With reference to FIGS. 11 to 13, an example of a method for learning a distortion amount in the present embodiment is described.

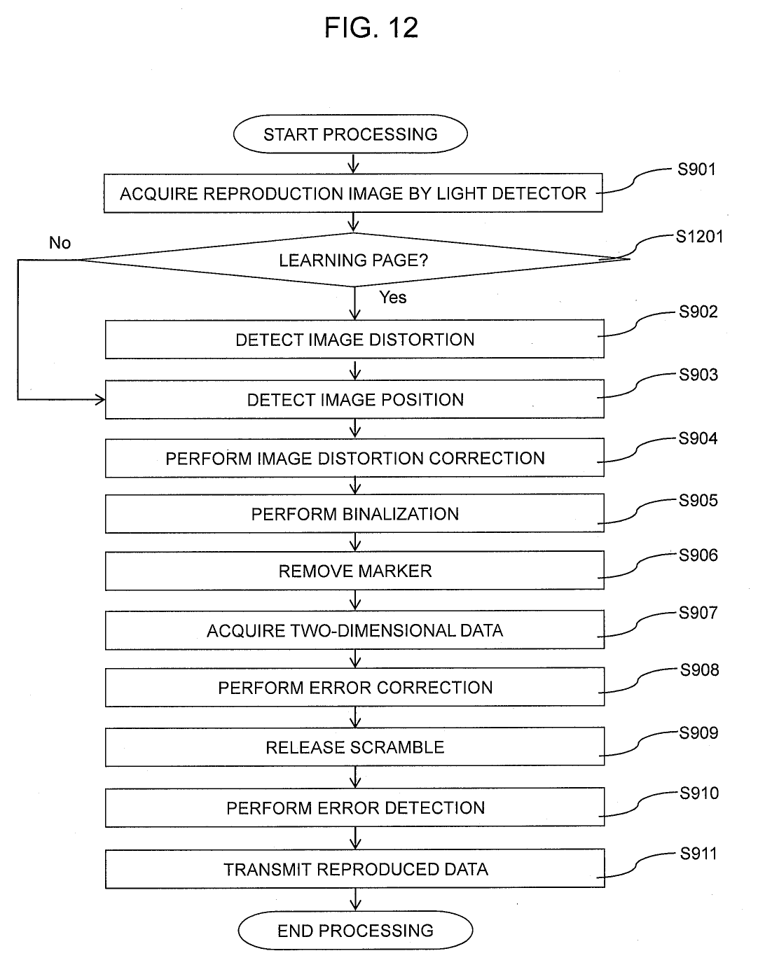

FIG. 11 is a block diagram illustrating a signal processing circuit 85 of an optical information recording/reproducing device 10 in the present embodiment. FIG. 12 is a flowchart of a data processing procedure of the signal processing circuit 85 at the time of reproducing. In the present embodiment, processing for determining whether a reproduction page is a learning page is added. In FIG. 11, a memory control circuit 703 controls a memory 702 so as to store, through a data line 713, the image data input from a pickup 11 through a pickup interface circuit 711, and then a distortion learning page determination circuit 1101 determines whether the data stored in the memory 702 is a distortion learning page (S1201). The determination method may be implemented by, for example, setting the first reproduction page of a book as a learning page, or recording the information in a part of page data.

When a reproduction image is a distortion learning page, a distortion learning circuit 101 performs distortion learning based on the information on the reproduction image (S902).

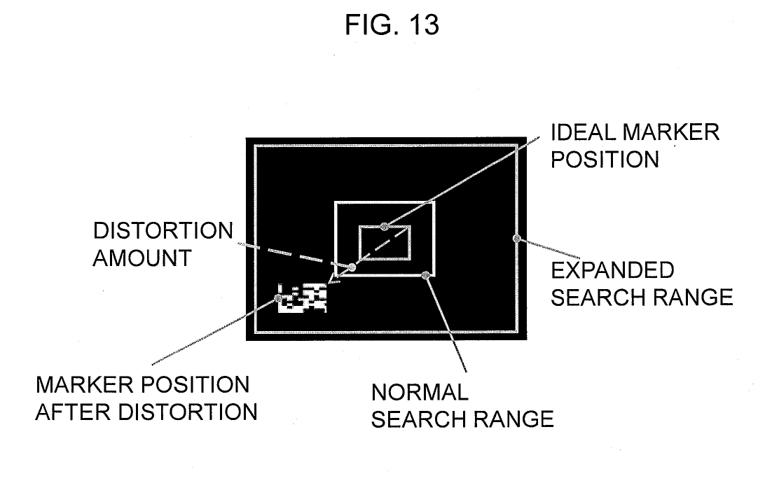

The distortion learning method using a learning page is described with reference to FIG. 13. When an image distortion occurs at the time of reproducing the learning page, the position of a marker in a page can be largely shifted from the ideal position and be out of the normal search range. Thus, when the learning page is reproduced, the marker is detected by expanding the normal search range and searching the expanded search range.

However, when the search range is expanded in a page in which data is displayed in the area other than the marker, the possibility that the wrong area is erroneously detected as the marker is increased as the area is expanded. Thus, by displaying no information in the area other than the marker in the learning page, the possibility of erroneous detection can be reduced. By performing such distortion amount calculation to all the markers, it is possible to accurately detect a marker and correct distortion although any kind of distortion occurs in a reproduction image while the possibility that the marker is erroneously detected is reduced.

As described above, by using the learning page having no data other than the marker, expanding the marker search range, and detecting the marker, it is possible to calculate distortion amount occurring in the reproduction image. Furthermore, by using the calculated distortion amount for searching for the marker when a normal page is reproduced, it is possible to perform correction according to the distortion amount.

It has been described that data is not recorded in the area other than the marker in the learning page in the present embodiment, any kind of pattern may be used unless the pattern causes erroneous detection of a marker. For example, by arranging a data pattern having a high cycle in the area other than the marker, the components other than the marker can be optically cut using a filter for cutting high-frequency components.

### Third Embodiment

The difference between the present embodiment and the first embodiment is that distortion learning is performed according to quality deterioration of a reproduction image and that a search range for a marker is expanded at the time of distortion learning.

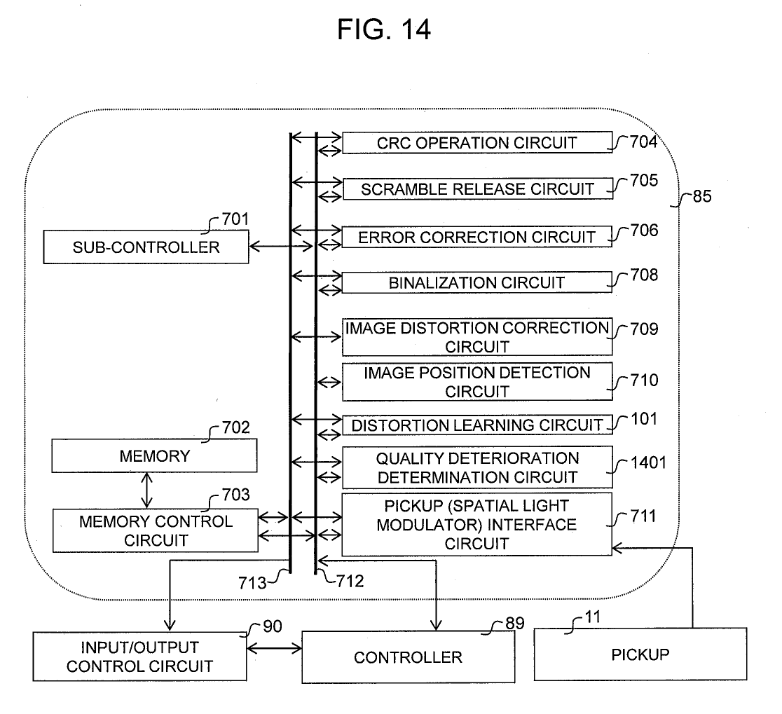

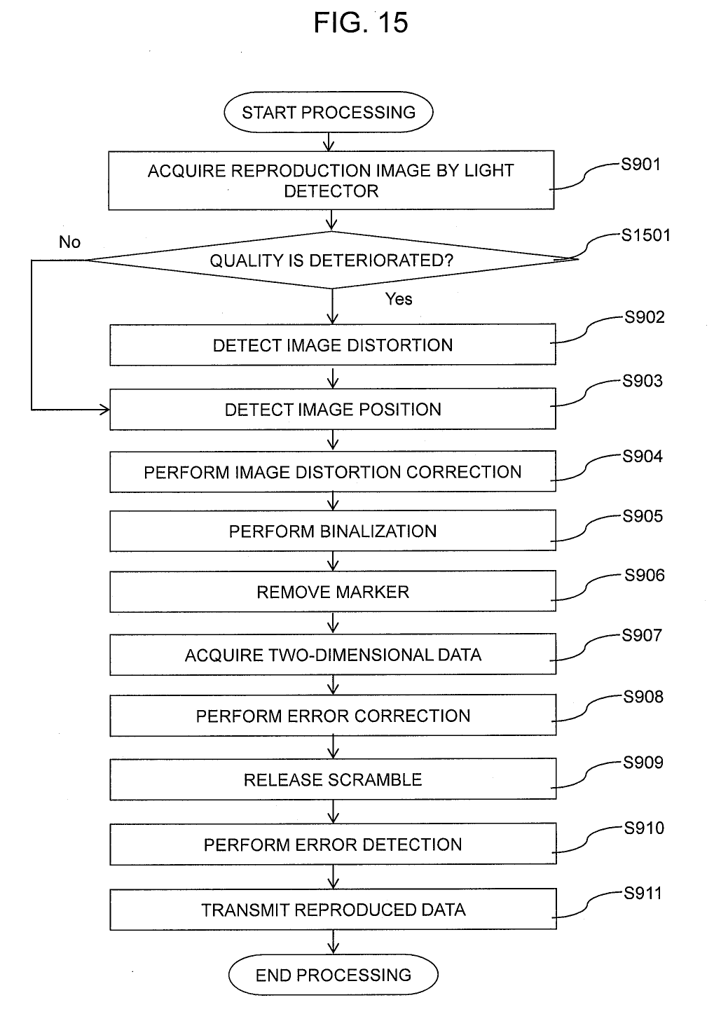

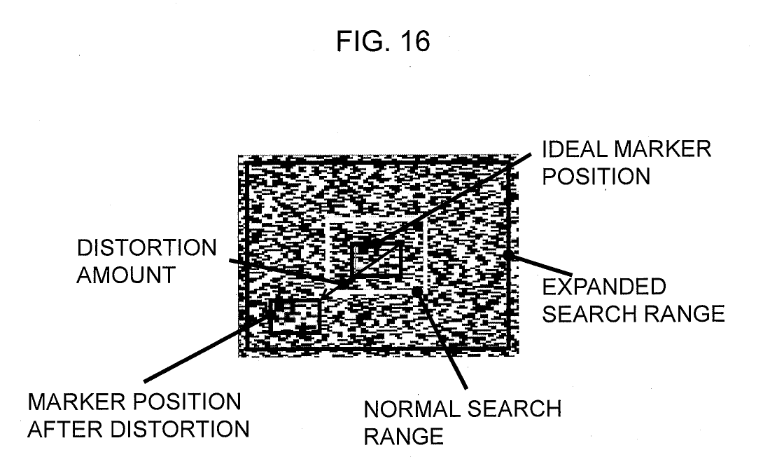

With reference to FIGS. 14 to 16, an example of a method for learning a distortion amount in the present embodiment is described. FIG. 14 is a block diagram illustrating a signal processing circuit 85 of an optical information recording/reproducing device 10 in the present embodiment. FIG. 15 is a flowchart of a data processing procedure of the signal processing circuit 85 at the time of reproducing. In the present embodiment, processing for determining whether quality of a reproduction image is deteriorated is added. In FIG. 14, a memory control circuit 703 controls a memory 702 so as to store, through a data line 713, image data input from a pickup 11 through a pickup interface circuit 711, and then a quality deterioration determination circuit 1401 determines whether the quality of the data stored in the memory 702 is deteriorated (S1501). The determination method may be implemented by, for example, setting a threshold using a specific evaluation index, such as a signal to noise ratio (SNR), or by performing determination based on the number of the erroneously detected markers from the result of the detection using the position information of the marker detection.

When the quality of the reproduction image is deteriorated, a distortion learning circuit 101 performs distortion learning based on the information on the reproduction image (S902).

When an image distortion occurs at the time of the distortion learning, the position of a marker in a page can be largely shifted from the ideal position and be out of the normal search range. Thus, when a learning page is reproduced, the marker is detected by expanding the normal search range and searching the expanded search range.

By performing such distortion amount calculation to all markers in all pages, it is possible to accurately detect a marker and correct distortion although any kind of distortion occurs in a reproduction image.

As described above, by expanding the marker search range according to the quality deterioration of the reproduction image, and detecting the marker, it is possible to calculate the distortion amount occurring in the reproduction image. Furthermore, by using the calculated distortion amount for searching for the marker when a normal page is reproduced, it is possible to perform correction according to the distortion amount.

### Fourth Embodiment

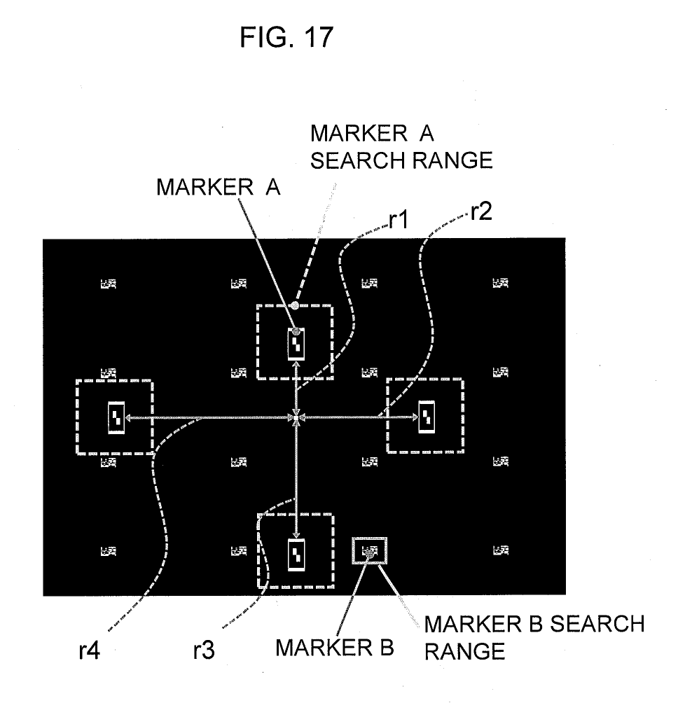

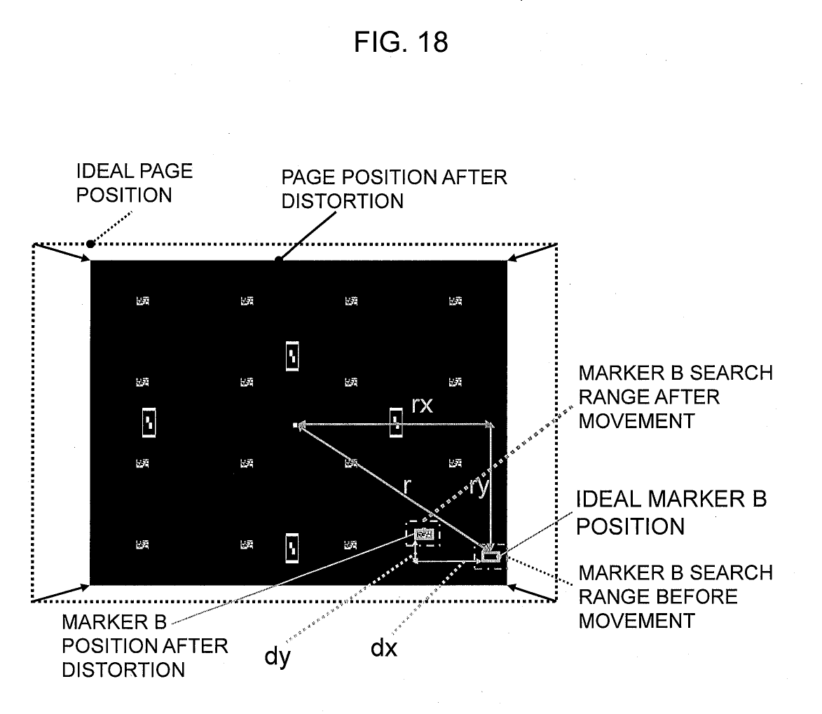

The difference between the present embodiment and the first embodiment is that a marker for learning a distortion amount and a marker for correcting distortion are simultaneously provided in a page, the distortion amount is learned using the marker for learning distortion, and the learned distortion amount is used for searching for the marker for correcting distortion. In the present embodiment, the marker for learning distortion is referred to as a marker A, and the marker for correcting distortion is referred to as a marker B. With reference to FIGS. 17 and 18, an example of a method for learning a distortion amount and using the distortion amount for searching a marker B search range in the present embodiment is described. FIG. 17 illustrates a page including the marker A and the marker B. Here, it is assumed that the page has four markers A and a plurality of markers B, and that the ideal distances from the center of the page to the markers A are r1, r2, r3, and r4. Furthermore, it is assumed that an X-direction component of r and a Y-direction component of r are rx and ry respectively. Moreover, it is assumed that the distances from the center of the page to the markers A after distortion are d1, d2, d3, and d4, and that an X-direction component of d and a Y-direction component of d are dx and dy respectively. Then, the distortion amount of the page can be calculated with the following expressions called the Brown's distortion model.

dx=rx(1+K1*r²K2*r⁴+ . . . )+(P1(r²+2*rx²)+2*P2*rx*ry)(1+P3*r²+P4*r⁴+ . . . )

dy=ry(1+K1*r²+K2*r⁴+ . . . )+(P1(r²+2*ry²)+2*P2*rx*ry)(1+P3*r²+P4*r⁴+ . . . )

By calculating two variables of K and P with the above expressions, the distortion amount can be represented, and the degrees of K and P are determined according to the number of markers A used for the calculation. When the number of calculated K and P becomes larger, the distortion amount can be more accurately represented, but the optimal degrees are determined according to the number of markers A which can be arranged in the page and the processing amount necessary for the calculation.

On the assumption that the optimal K and P are calculated with the above Brown's model, a method for moving a marker B search range when the marker B is searched for is described with reference to FIG. 18. FIG. 18 illustrates that an image is reduced with distortion. Here, a method for correcting the marker B search range at lower right of the page is exemplified. It is assumed that the ideal position from the center of the page to each marker B before distortion is r. Furthermore, it is assumed that an X-direction component of r and a Y-direction component of r are rx and ry respectively. Then, by applying them to the Brown's distortion model together with the optimal coefficients K and P, the movement amounts of dx and dy of the marker B search range from the marker B search range before movement to the marker B search range after movement can be calculated. By searching for the marker in the marker B search range moved by dx and dy, the marker can be detected. As described above, by performing the distortion learning using the markers A provided in the page, and determining the search range for each marker B based on the learned distortion amount, it is possible to implement the signal processing method for compensating distortion in each page. Although four markers A are used in the present embodiment, the number of markers A is not limited as long as the distortion amount can be calculated according to the arrangement and the number of markers A. Furthermore, the number of markers B is not limited since the compensation to the entire page can be more accurately performed as the number of markers B becomes larger. Moreover, the kinds of marker embedded in the page are not limited to two. Consequently, it is possible to accurately calculate a distortion amount according to an assumed distortion, and which leads the improvement of quality. Furthermore, since the search range corresponding to each marker B is moved according to each distortion amount calculated with the above Brown's distortion model, it is possible to detect a known pattern according to a nonlinear distortion.

Furthermore, the present invention is not limited to the above described embodiments, and includes various modifications. For example, the above embodiments are described in details to easily understand the present invention, and not limited to the configurations having all the described components. Apart of the configuration of one embodiment may be replaced with a part of the configuration of another embodiment, and a configuration of one embodiment may include a configuration of another embodiment. Furthermore, in a part of the configuration of each embodiment, it is possible to add, delete, or replace another configuration.

Furthermore, a part of or all of the above configurations, functions, processing units, processing means, or/and the like may be implemented by hardware, for example, by designing an integrated circuit. Moreover, the above configurations, functions, or/and the like may be implemented by software by interpreting and executing a program which implements the functions by a processor. Programs implementing the functions and information, such as a table, a file, and the like, can be stored in a recording device, such as a memory, a hard disk, or a solid state drive (SSD), or in a storage medium, such as an IC card, an SD card, or a DVD.

Note that, the control line and the information line which are necessary for the description are illustrated, and all control lines and all information lines which are necessary for an actual product are not necessarily illustrated. Practically, it can be considered that most of all configurations are mutually connected.

What is claimed is:

1. An optical information reproducing device which reproduces information from an optical information storage medium recording, as the information, a hologram which is an interference pattern between a signal beam and a reference beam, the hologram corresponding to an angle of the reference beam being a page, the optical information reproducing device comprising:
an image distortion learning unit configured to detect, based on a two-dimensional reproduction signal generated by reproducing the page, a marker which is a known pattern for detecting a position of two-dimensional data relating to the page, and to learn a distortion amount which is the difference between a position of the detected marker and an ideal position of the marker;
a detection unit configured to detect, based on the distortion amount, position information on the marker from the page; and
an image distortion correction unit configured to correct, based on the position information on the marker detected by the detection unit, an image distortion in the page.

2. The optical information reproducing device according to claim 1, wherein the detection unit controls a search range for the marker based on the distortion amount, and detects the position information on the marker.

3. The optical information reproducing device according to claim 1, wherein
the image distortion learning unit learns the distortion amount of the page using the marker, and
a search range for the marker is larger than a search range for the marker by the detection unit.

4. The optical information reproducing device according to claim 1, further comprising:
a distortion learning page determination unit configured to determine whether the page to be reproduced is a learning page in which data is not recorded in an area other than the marker, wherein
the image distortion learning unit learns the distortion amount using the distortion learning page.

5. The optical information reproducing device according to claim 1, further comprising:
a quality deterioration determination unit configured to determine whether quality of the page to be reproduced is deteriorated, wherein
the image distortion learning unit learns the distortion amount based on a determination result by the quality deterioration determination unit.

6. The optical information reproducing device according to claim 1, wherein
the marker which is a known pattern for learning the image distortion in the page to be reproduced is a first marker,
the marker which is a known pattern for correcting the image distortion is a second marker,
the image distortion learning unit searches for the first marker, and
the detection unit searches for the second marker.

7. The optical information reproducing device according to claim 6, wherein the image distortion learning unit learns the distortion amount based on the detected first marker, controls a search range for the second marker based on the learned distortion amount, and detects position information on the second marker.

8. An optical information reproducing method for reproducing information from an optical information storage medium recording, as the information, a hologram which is an interference pattern between a signal beam and a reference beam, the hologram corresponding to an angle of the reference beam being a page, the optical information reproducing method comprising:
an image distortion learning step of detecting, based on a two-dimensional reproduction signal generated by reproducing the page, a marker which is a known pattern for detecting a position of two-dimensional data relating to the page, and of learning a distortion amount which is the difference between a position of the detected marker and an ideal position of the marker;
a detection step of detecting, based on the distortion amount, position information on the marker from the page; and
an image distortion correction step of correcting, based on the position information on the marker detected in the detection step, an image distortion in the page.

9. The optical information reproducing method according to claim 8, wherein a search range for the marker is controlled based on the distortion amount, and the position information on the marker is detected in the detection step.

10. The optical information reproducing method according to claim 8, wherein
the distortion amount of the page is learned using the marker in the image distortion learning step, and
a search range for the marker is larger than a search range for the marker in the detection step.

11. The optical information reproducing method according to claim 8, further comprising:
a distortion learning page determination step of determining whether the page to be reproduced is a learning page in which data is not recorded in an area other than the marker, wherein
the distortion amount is learned using the distortion learning page in the image distortion learning step.

12. The optical information reproducing method according to claim 8, further comprising:
a quality deterioration determination step of determining whether quality of the page to be reproduced is deteriorated, wherein
the distortion amount is learned based on a determination result by the quality deterioration determination step in the image distortion learning step.

13. The optical information reproducing method according to claim 8, wherein
the marker which is a known pattern for learning the image distortion in the page to be reproduced is a first marker,
the marker which is a known pattern for correcting the image distortion is a second marker,
the first marker is searched for in the image distortion learning step, and
the second marker is searched for in the detection step.

14. The optical information reproducing method according to claim 13, wherein the distortion amount is learned based on the detected first marker, a search range for the second marker is controlled based on the learned distortion amount, and position information on the second marker is detected in the image distortion learning step.
